(19) United States
(12) Patent Application Publication
(10) Pub. No.: US 2006/0252406 A1
(43) Pub. Date: Nov. 9, 2006

(54) System and method for providing bundle group termination in an OSGi service platform

(75) Inventors: Daniel Fey, Budapest (HU); Andras Boros, Budapest (HU)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/113,605

(22) Filed: Apr. 25, 2005

(51) Int. Cl. H04Q 7/20

(52) U.S. Cl. 455/403

(57) ABSTRACT

A system and method for defining a termination set of bundles of extensible and downloadable service applications. For each bundle to be analyzed, all bundles that are sharing a package with the selected bundle are located. All bundles that are dependent upon threads to the selected bundle are also located. The located bundles are then added to the group of bundles to be analyzed, as well as to a group of bundles to be terminated. The bundles in the termination set can then be terminated, which permits the achievement of full reclamation, even for those bundles that are not in an ACTIVE state but still consume resources.

### FIELD OF THE INVENTION

The present invention relates generally to the OSGi service platform. More particularly, the present invention relates to the termination of bundles of extensible and downloadable service applications in the OSGi framework.

### BACKGROUND OF THE INVENTION

OSGi, which stands for “Open Services Gateway Initiative” and is discussed at www.osgi.org, is an open, common architecture to deploy and manage services in a coordinated manner. OSGi provides a general-purpose, secure, managed Java-based framework that supports the deployment of extensible and downloadable service applications known as bundles. OSGi-compliant devices can download and install OSGi deployment entities and remove them when they are no longer required. Installed and started bundles can register a number of services that can be shared with other bundles under strict control of the framework.

OSGi can run on the top of a standard Java virtual machine (VM). Contrary to traditional methods where one Java application runs on one VM, several bundles can be simultaneously run on the same VM in OSGi. Using OSGi, there is no need to load and execute the VM as many times as the number of the running Java applications. Thus, memory consumption is greatly reduced.

OSGi bundles have a well-defined lifecycle, which is depicted in FIG. 1. The framework reports the lifecycle changes of bundles to other bundles via events of the class “BundleEvent.”

In order to ensure that the resource consumption of the OSGi runtime is not growing continuously, when a bundle is stopped, it must release all of the resources that had been allocated since activation, as is required in Section 4.8.7 of the current OSGi R3 specification. According to Section 4.8.7 of the OSGi R3 specification, the BundleActivator interface defines a “public void stop (BundleContext context) throws Exception” method, which is invoked by the framework to stop a bundle. This method must release any resources that were allocated since activation. All threads associated with the stopping bundle should be stopped immediately.

An important feature of bundles is that they are able to share Java code with other bundles. Technically, this is achieved by exporting a part of the Java packages contained by the bundle to the namespace database maintained by the OSGi framework, permitting other bundles to import and use these packages. The availability of the exported packages is tied to the lifecycle stages of the bundle; the exported packages must be made continuously available while the bundle is cycling between RESOLVED and ACTIVE states. If the bundle's dependencies are resolved, selected packages must be exported. Packages exported by a stopped bundle continue to be available to other bundles. This continued export implies that other bundles can execute code from a stopped bundle.

OSGi also introduces the concept of “service.” According to the current OSGi R3 framework specification, for the OSGi service platform, bundles are built around a set of cooperating services that are available from a shared service registry. Such an OSGi service is defined semantically by its service interface and is implemented as a service object. The service interface should be specified with as few implementation details as possible. The service object is owned by, and runs within, a bundle. This bundle must register the service object with the framework service registry so that the service's functionality is available to other bundles under the control of the framework.

Dependencies between the bundle that owns the service and the bundles using the service are managed by the framework. For example, when a bundle is stopped, all of the services registered with the framework by that bundle will be automatically unregistered. The framework maps services to their underlying service objects and provides a query mechanism that enables an installed bundle to request the services it needs. The framework also provides an event mechanism so that bundles can receive events of class “ServiceEvent” that are registered, modified, or unregistered. It is also notable that a ServiceEvent reports registration, unregistration, and property changes for service objects. All events of this kind must be synchronously delivered.

The OSGi specifications currently require that a stopping bundle must stop its threads and clean up its resources. At the same time, OSGi does not specify any infrastructure that makes this requirement enforceable. Malicious bundles or bug-prone bundles may ignore this requirement. As a result, only a full restart of the framework can address this issue. Unfortunately, a full restart interrupts the availability of the functionality provided by the OSGi runtime. In a system that is expected to run in a 24/7 environment and provide crucial functionality, such a deficiency is not tolerable.

The OSGi specifications also require that the exported packages of a bundle need to be available even when a bundle is stopped. The users or importers of the exported packages must not experience the exported packages becoming inconsistent as a consequence of the stopping of the exporting bundles. An OSGi-compliant solution for forced bundle stopping must ensure these requirements.

Due to some special features of the Java language, a bundle may consume resources and own threads even if the bundle was never started. This phenomenon is because of the use of the bundle's exported packages. Bundles staying in the RESOLVED state cannot be stopped, since the stop operation is defined only for bundles staying in the ACTIVE state. OSGi does not define any facilities that can be used to ask a bundle staying in the RESOLVED state to clean up its resources.

It would therefore be desirable to provide an infrastructure that is capable of achieving forced resource reclamation without the entire operating system process running the Java VM that powers the OSGi runtime having to be restarted.

### SUMMARY OF THE INVENTION

The present invention involves the use of bundle termination, which is a forced operation that results in the termination of all threads and the reclamation of all resources owned by a particular bundle. In the event that a bundle has to be terminated for any reason, the following steps are taken. First, the bundle's termination set is defined. All bundles that depend upon the bundle selected to be terminated are members of the termination set. No bundles that are not members of the termination set can depend upon any member of the termination set. Second, as a single management operation, the member bundles of the termination set that are in ACTIVE state are stopped, and all of the members of the termination set are terminated, regardless whether the members were in the ACITVE or RESOLVED state before the management operation was started.

The present invention achieves full resource reclamation, even for those bundles that are not in the ACTIVE state but still consume resources. Bundles that are not included in the termination set and respect the OSGi recommendations will not be harmed by the termination of members of the termination set.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation showing the lifecycle of OSGi bundles;

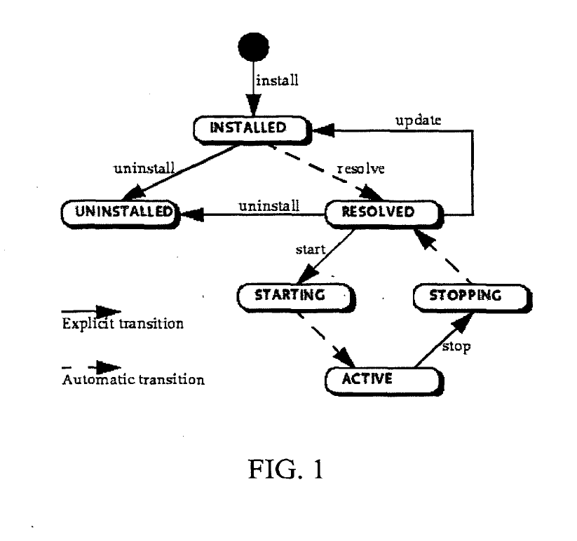

FIG. 2 is a perspective view of a mobile telephone that can be used in the implementation of the present invention;

FIG. 3 is a schematic representation of the telephone circuitry of the mobile telephone of FIG. 2;

FIG. 4 is a flow chart showing an algorithm for finding a termination set according to one embodiment of the present invention; and

FIG. 5 is a flow chart showing an algorithm for finding invalid references according to one embodiment of the present invention.

### DETAILED DESCRIPTION OF THE PREFERRED EMBODIMENTS

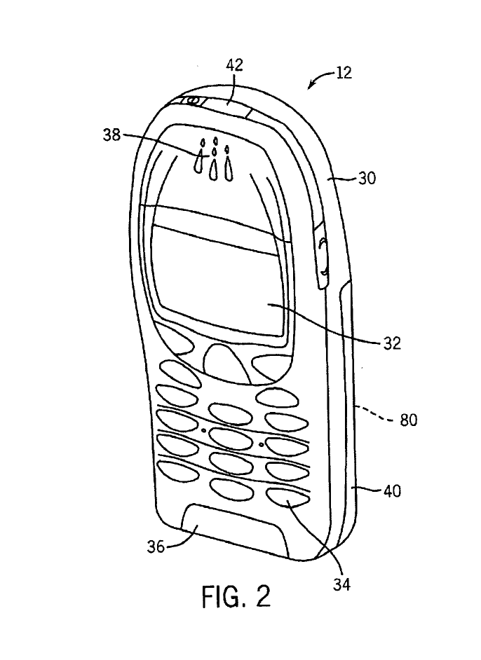

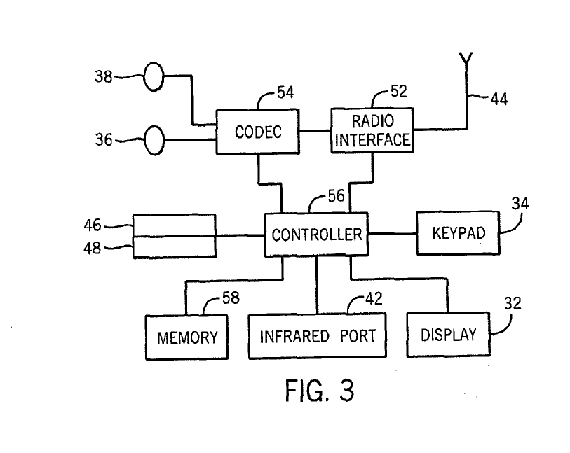

FIGS. 2 and 3 show one representative mobile telephone 12 within which the present invention may be implemented. It should be understood, however, that the present invention can be implemented into a wide variety of electronic devices, including personal computers, personal digital assistants, integrated messaging devices, and other electronic devices. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention involves the use of bundle termination, which is a forced operation that results in the termination of all of the threads and the reclamation of all of the resources owned by a particular bundle. In the event that a bundle has to be terminated for any reason, a number of steps are taken to complete this action. First, the bundle's termination set is identified. A termination set is the smallest set of bundles that conforms to a pair of rules. The first rule is that all bundles that depending on the bundle selected to be terminated are members of the termination set. According to the second rule, no bundles that are not members of the termination set depend on any member of the termination set. Second, as a single management operation, the member bundles of the termination set that are in ACTIVE state are stopped, and all of the members of the termination set are terminated, regardless whether the members were in the ACITVE or RESOLVED state before the management operation was started.

A number of dependency types must be considered in finding the termination set. Dependencies induced by the package sharing mechanism must be considered. Dependencies arising in conjunction with thread termination are also considered—when a thread of a bundle is terminated while it is executing the code of exported packages of another bundle, it might leave those packages in an inconsistent state.

The present invention assumes that certain functionalities are available in the system at issue. For example, it is assumed that a working mechanism is able to decide for every particular resource which bundle is its owner. It is also assumed that a working mechanism exists for terminating the threads of a particular bundle. In addition, it is assumed that the instant termination of threads is not harming the state of the virtual machine and the state of the native resources of the whole operating system process running the virtual machine. It is also assumed that a working mechanism is available for the full reclamation of the resources owned by the bundles (including the native resources).

Considering dependency types, the first category of dependencies is based upon the mechanism of the package sharing. If a bundle imports the packages of another bundle, the importer bundle clearly has a dependency towards the exporter. It is not even necessary to have objects instantiated from the code of the exporter, because objects referenced by static fields of the exported packages (if there are any) can be manipulated without holding any direct reference to them. This type of dependency, directed from the importer bundle towards the exporter bundle, is referred to herein as package dependency.

A second category of dependencies is formed by the consequences of the thread termination. Before defining this category of dependencies, the extent to which bundles are thread termination-safe must be established. Two types of bundles share packages—thread termination-safe bundles and termination-unsafe bundles. The first type includes bundles that are prepared and are resistant to the instant thread termination. It is ensured that the instant termination of a thread that is executing the code of the exported packages does not leave the resources of the bundle owning the exported pages in an inconsistent state. In a robust OSGi system, all bundles that are providing crucial services (standard services defined by the OSGi specification) or are sharing packages of important APIs must be resistant to instant thread termination. Bundles that are deploying code that handle native resources (e.g. uses native calls) must also belong to this category since, in a different case, if a thread is instantly terminated, it might leave the native resources in an inconsistent state. This may result in damage to the whole operating system process.

The second type of bundles that share code packages are bundles that are not resistant to the instant thread termination, referred to as termination-unsafe bundles. The state of these bundles becomes undefined if a thread executing their code is instantly terminated.

The following is an example showing the relevance of the two types of bundles. In a situation where a bundle X is terminated, all of its threads are terminated. X imports some packages exported by a bundle, referred to herein as Y, that is not resistant to instant thread termination. In this case, Y is potentially in danger of the consequences of instant thread termination, because the threads of X might actually be executing Y's exported code. A more precise recognition of this danger can be based on a system functionality that logs whether a bundle (any thread of a bundle) has ever executed the code of an exported bundle. A more precise recognition form of this dependency can be based on a call stack analysis that decides whether a thread that will be terminated is actually executing a method of the exported packages of a particular bundle.

In the dependency type described above, which is directed from the exporter bundle falling in the second type of bundles towards the importer bundle, is referred to as thread dependency. It is up to the system implementation as to whether it recognizes this dependency in a precise form or in a simple, but not precise, form.

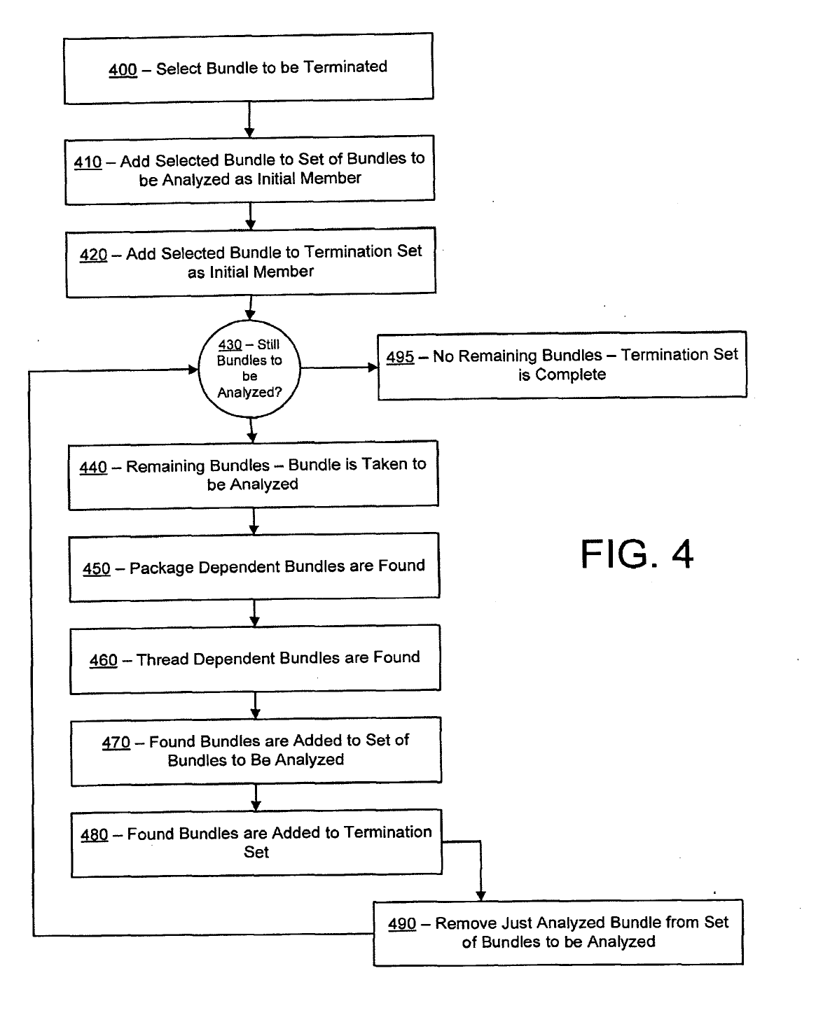

An algorithm used to find the termination set for the present invention is depicted in FIG. 4. The algorithm operates by building two sets: the set of bundles whose dependencies need to be analyzed, and the termination set. Bundles from the former set are analyzed and moved, if needed, to the latter set. When the algorithm finished, the latter set comprises the termination set. At step 400, the bundle that was initially marked to be terminated is selected. At step 410, the selected bundle is added to the set of bundles to be analyzed as an initial member. At step 420, the selected bundle is added to the termination set as an initial member. It is then determined at step 430 whether there are bundles in the set of bundles that still must be analyzed. If there are bundles that still need to be analyzed, then at step 440, a bundle is taken from the set of bundles remaining to be analyzed. At step 450, al. package-dependent bundles are found. At step 460, all thread-dependent bundles are found. At step 470, the found bundles are added to the set of bundles to be analyzed. At step 480, the found bundles are added to the termination set. At step 490, the bundle that was just analyzed is removed from the set of bundles remaining to be analyzed, and the process returns to step 430. If all of the bundles have then been analyzed, the process for finding the termination set is complete, which is represented at step 495.

There is also an issue of invalid object reference being created during a forceful resource reclamation. In some circumstances, bundles may hold references to objects of another bundle, even when they are not importing and, depending upon the code exported by the bundle, which owns the referenced objects. In this case, the bundle that keeps the references might not be a member of the termination set. For example, bundle X may be a member of the termination set, while bundle Y is not a member. X imports packages exported by Y. Through method calls provided by Y's exported packages, it is possible to store direct references in objects owned by Y to objects owned by X. In another example, direct reference-based inter-bundle communication via service objects may be used.

According to the requirements of the OSGi framework specification, the framework generates events when a service is unregistered or a bundle is stopped. Well-behaving bundles should react to these events and clear references to objects that are owned by other bundles. Some situations may exist where when the bundle that keeps references to objects of foreign bundles does not clear, or where it is not able to clear its foreign references. For example, the code that manipulates the foreign references might be in an imported package (and the exporter bundle is not a member of the termination set, since in a different case this would mean that the bundle that owns the foreign reference must also be a member of the termination set), and the code in the imported package may not be well written.

This problem identified above is addressed as follows according to one embodiment of the present invention. An algorithm finds all of the references that point from objects of bundles that are not member of the termination set towards objects of members of the termination set. All of these references are invalidated with the help of the virtual machine by ensuring that an execution thread that tries to use an invalid reference will receive a runtime exception. The exception is public, and the code that is suspected of using foreign references can prepare for such a situation by putting the critical part into a try-catch block. Since there is no such mechanism in OSGi or standard Java, bundles that are not prepared to be run on a resource management-enabled framework might be unable to handle the exception. When the use of the invalid reference occurs, which can happen at any time after terminating bundles in a termination set, the bundle are also terminated in accordance with the present invention.

In one embodiment of the present invention, foreign references can be considered as an additional dependency type. In this situation, a bundle is added to the termination set, as well as to the set of bundles that should be analyzed if the bundle holds a reference to a bundle contained by the termination set.

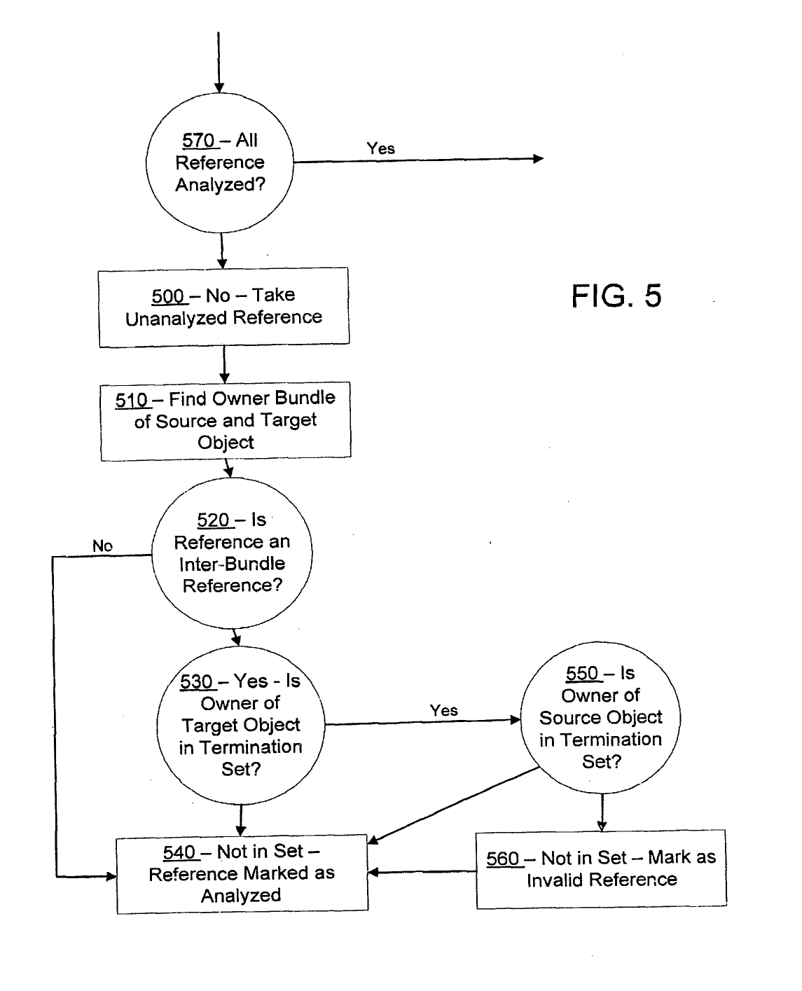

FIG. 5 is a flow chart showing the operation of the algorithm that is used to find the invalid references caused by the resource reclamation according to one embodiment of the present invention. The algorithm is preferably performed after all of the bundles have received the event signalling that the active bundles that are members of the termination set are stopped. At step 500 in FIG. 5, a reference that has not been analyzed is taken. At step 510, the owner bundle of the source, and the owner bundle of the target object of the reference is found. At step 520, it is determined whether the reference is an inter-bundle reference, or if the source and the target object of the reference are owned by the same bundle. If the reference is an inter-bundle reference, then at step 530, it is determined whether the owner bundle of the target object is in the termination set. If it the owner bundle is not in the termination set, then the reference is marked as “analyzed” at step 540. The reference is also marked as “analyzed” if the source and the target reference are owned by the same bundle. If the owner bundle of the target object is in the termination set, it is then determined at step 550 whether the owner bundle of the source object of the reference is in the termination set. If the owner bundle of the source object of the reference is in the termination set, then the reference is marked as “analyzed.” If the owner bundle of the source object of the reference is not in the termination set, then the reference is marked as an invalid reference at step 560, which is followed by the reference being marked as “analyzed.” After the reference has been marked as “analyzed,” it is determined at step 570 whether all of the references have been analyzed. If so, then the process is complete; otherwise, the process begins again for a reference that has yet to be analyzed.

The system may notify the user about the termination process in one embodiment of the invention. The information about the members of the termination set for a particular bundle may be valuable for an advanced user and may provide “hints” for taking further actions (e.g. to uninstall the member bundles of the termination set).

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software implementations of the present invention could be accomplished with standard programming techniques with rule-based logic and other logic to accomplish the various database searching steps, correlation steps, comparison steps and decision steps. It should also be noted that the words “component” and “module” as used herein, and in the claims, are intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for terminating bundles in an OSGi framework, comprising:
upon a bundle being selected for termination, identifying a termination set, wherein bundles that depend on the selected bundle are included in the termination set, and wherein bundles that are not members of the termination set do not depend upon any member of the termination set;
stopping member bundles of the termination set that are in an ACTIVE state; and
terminating members of the termination set regardless of whether the members were in the ACTIVE or the RESOLVED state before the initiation of a management operation.

2. The method of claim 1, wherein the identification of the termination set includes:
performing an iterative process, including:
selecting a bundle from a group of bundles to be analyzed,
locating all bundles that are package dependent upon the selected bundle,
locating all bundles that are thread dependent upon the selected bundle,
adding the located bundles to the group of bundles to be analyzed,
adding the located bundles to the termination set, and
removing the selected bundle from the group of bundles to be analyzed;
repeating the iterative process until there are no remaining bundles in the group of bundles to be analyzed.

3. The method of claim 2, further comprising:
before beginning the iterative process, selecting a bundle that has been initially marked to be terminated;
creating the group of bundles to be analyzed by adding the initially marked bundle; and
creating the termination set by adding the initially marked bundle.

4. The method of claim 1, further comprising notifying a user of the bundles of the termination set.

5. The method of claim 1, wherein a particular bundle is package dependent upon another bundle if the particular bundle imports packages exported by the another bundle.

6. The method of claim 1, wherein a particular bundle is thread dependent upon a second bundle having threads if instant termination of the threads of the second bundle leaves resources of the particular bundle in an inconsistent state.

7. A computer program product for terminating bundles in an OSGi framework, comprising:
computer code for, upon a bundle being selected for termination, identifying a termination set, wherein bundles that depend on the selected bundle are included in the termination set, and wherein bundles that are not members of the termination set do not depend upon any member of the termination set;
computer code for stopping member bundles of the termination set that are in an ACTIVE state; and
computer code for terminating members of the termination set regardless of whether the members were in the ACTIVE or the RESOLVED state before the initiation of a management operation.

8. The computer program product of claim 7, wherein the identification of the termination set includes:
computer code for, performing an iterative process, including:
computer code for selecting a bundle from a group of bundles to be analyzed,
computer code for locating all bundles that are package dependent upon the selected bundle,
computer code for locating all bundles that are thread dependent upon the selected bundle,
computer code for adding the located bundles to the group of bundles to be analyzed,
computer code for adding the located bundles to the termination set, and
computer code for removing the selected bundle from the group of bundles to be analyzed;
computer code for, repeating the iterative process until there are no remaining bundles in the group of bundles to be analyzed.

9. The computer program product of claim 8, further comprising:
computer code for before beginning the iterative process, selecting a bundle that has been initially marked to be terminated;
computer code for creating the group of bundles to be analyzed by adding the initially marked bundle; and
computer code for creating the termination set by adding the initially marked bundle.

10. The computer program product of claim 7, further comprising computer code for notifying a user of the bundles of the termination set.

11. The computer program product of claim 7, wherein a particular bundle is package dependent upon another bundle if the particular bundle imports packages exported by the another bundle.

12. The computer program product of claim 7, wherein a particular bundle is thread dependent upon a second bundle having threads if instant termination of the threads of the second bundle leaves resources of the particular bundle in an inconsistent state.

13. An electronic device, comprising:
a processor; and
a memory unit operatively connected to the processor and including a computer program product for terminating bundles in an OSGi framework, comprising:
computer code for, upon a bundle being selected for termination, identifying a termination set, wherein bundles that depend on the selected bundle are included in the termination set, and wherein bundles that are not members of the termination set do not depend upon any member of the termination set;
computer code for stopping member bundles of the termination set that are in an ACTIVE state; and
computer code for terminating members of the termination set regardless of whether the members were in the ACTIVE or the RESOLVED state before the initiation of a management operation.

14. The electronic device of claim 13, wherein the identification of the termination set includes:
computer code for, performing an iterative process, including:
computer code for selecting a bundle from a group of bundles to be analyzed,
computer code for locating all bundles that are package dependent upon the selected bundle,
computer code for locating all bundles that are thread dependent upon selected bundle,
computer code for adding the located bundles to the group of bundles to be analyzed,
computer code for adding the located bundles to the termination set, and
computer code for removing the selected bundle from the group of bundles to be analyzed;
computer code for repeating the iterative process until there are no remaining bundles in the group of bundles to be analyzed.

15. The electronic device of claim 14, wherein the memory unit further comprises:
computer code for before beginning the iterative process, selecting a bundle that has been initially marked to be terminated;
computer code for creating the group of bundles to be analyzed by adding the initially marked bundle; and
computer code for creating the termination set by adding the initially marked bundle.

16. The electronic device of claim 13, wherein a particular bundle is package dependent upon another bundle if the particular bundle imports packages exported by the another bundle.

17. The electronic device of claim 13, wherein a particular bundle is thread dependent upon a second bundle having threads if instant termination of the thread of the second bundle leaves resource of the particular bundle in an inconsistent state.

18. The electronic device of claim 13, wherein the memory unit further comprises computer code for notifying a user of the bundles of the termination set.
